(19) United States
(12) Patent Application Publication
(10) Pub. No.: US 2020/0324311 A1
(43) Pub. Date: Oct. 15, 2020

(54) DEVICE FOR DEPOSITING A BEAD OF A PLASTIC SUBSTANCE AND METHOD FOR IMPLEMENTING SAME

(71) Applicant: Safran Nacelles, Gonfreville L'Orcher (FR)

(72) Inventors: Didier BARBARIT, SAINT GEORGES DE MONTAIGU (FR); Erwan JANTY, GONFREVILLE L'ORCHER (FR); Bertrand SOUFFLET, GONFREVILLE L'ORCHER (FR)

(73) Assignee: Safran Nacelles, Gonfreville L'Orcher (FR)

(21) Appl. No.: 16/914,848

(22) Filed: Jun. 29, 2020

Related U.S. Application Data
(63) Continuation of application No. PCT/FR2018/053541, filed on Dec. 24, 2018.

(30) Foreign Application Priority Data
Dec. 29, 2017 (FR) 17/63352

(51) Int. Cl. B05C 5/02; B25J 15/00; B25J 13/08; B25J 9/16; B25J 19/02; B25J 9/12; B05D 1/26; B05C 11/10

(52) U.S. Cl. CPC B05C 5/0216; B25J 15/0019; B25J 13/085; B25J 9/1664; B25J 9/1633; B05C 11/1015; B25J 13/088; B25J 19/023; B25J 9/123; B25J 9/1674; B05D 1/265; B25J 13/08

(57) ABSTRACT

A device for depositing a bead of a plastic substance on a profile includes a robotic arm, a deposition effector including an extrusion nozzle that is linked to a supply of plastic substance and that extends axially along an extrusion axis (A), and a force feedback sensor for measuring the force applied by the nozzle to the profile during the deposition of the bead. The device further includes an electronic computer implementing a computer program that is designed to control the robotic arm in space along a predetermined theoretical trajectory, and correct the theoretical trajectory according to the measurements made by the force feedback sensor, such that the bearing force (F) of the nozzle on the profile, measured by the force feedback sensor, tends towards a predefined value, in order to allow the nozzle to remain in contact on the profile.

### CROSS-REFERENCE TO RELATED APPLICATIONS

This application is a continuation of International Application No. PCT/FR2018/053541, filed on Dec. 24, 2018, which claims priority to and the benefit of FR 17/63352 filed on Dec. 29, 2017. The disclosures of the above applications are incorporated herein by reference.

### FIELD

The present disclosure relates to field of depositing a bead of a plastic material on a profile.

### BACKGROUND

The statements in this section merely provide background information related to the present disclosure and may not constitute prior art.

It is known to deposit a bead of a plastic substance, for example a mastic sealant, on a profile, for example in order to make a sealing gasket.

The profile is typically delimited by two faces which belong to two distinct parts, the bead allowing sealing between the two faces.

In the aeronautical field, a plastic substance bead must meet quality criteria.

In particular, these quality criteria concern the shape of the bead, the smoothing of the bead, the absence of burrs beyond the bead, the regularity of the bead and the match of the profile by the bead.

A manual deposition of the bead consists in successively depositing the bead on the profile, smoothing the bead and then checking up the bead visually.

A drawback of manually depositing the bead lies in the difficulty to meet the quality criteria defined hereinabove.

In addition, the manual deposition of the bead is difficult to replicate in an identical manner, differences in quality may appear from one bead to another, in particular if several operators are in charge of making the beads.

### SUMMARY

This section provides a general summary of the disclosure and is not a comprehensive disclosure of its full scope or all of its features.

The present disclosure relates to a device for depositing a bead of a plastic substance on a profile delimited by at least one face for depositing the bead, the device including a robotic arm, a deposition effector comprising an extrusion nozzle which is connected to a plastic substance storage and which extends axially along an extrusion axis, and a force feedback sensor which allows measuring the force applied by the nozzle on the profile during the deposition of the bead. The device comprises an electronic calculator implementing a computer program which is designed so as to pilot the robotic arm in space according to a theoretical trajectory which is predetermined and correct the theoretical trajectory according to the measurements collected by the force feedback sensor, so that the bearing force of the nozzle on the profile, measured by the force feedback sensor, tends towards a predefined value, so as to enable the nozzle to remain in contact on the profile.

The device according to the present disclosure allows obtaining a bead which meets the quality criteria and which is capable of adapting to any type of profile.

In addition, the device allows following the profile of the part even when the profile has a dispersion or a defect that is not reported by the theoretical trajectory of the robotic arm.

According to another feature, the predefined value is equal to about ten Newtons.

This value reduces the possibility of altering the profile.

According to another feature, the device includes a deposition sensor which is adapted to measure the amount of plastic substance deposited on the profile, the speed of displacement of the robotic arm being servo-controlled according to the amount of plastic substance actually deposited.

This feature allows correcting a possible divergence between the plastic substance flow rate and the speed of displacement of the nozzle.

According to another feature, the deposition sensor is a laser sensor which is directed towards the deposited plastic substance bead.

According to another feature, the speed of displacement of the robotic arm is servo-controlled according to the speed of extrusion of the plastic substance.

This feature allows obtaining a bead with a constant geometry.

According to another feature, the device includes a monitoring member which is adapted to collect monitoring data relating to the physical aspect of the plastic substance bead, and the computer program is designed so as to process the monitoring data and validate or invalidate the quality of the deposited plastic substance bead.

This feature allows doing without a visual check-up of the bead by an operator.

According to another feature, the monitoring data are collected by the monitoring member during the deposition of the bead.

According to another feature, a smoothing of the bead is carried out by the extrusion nozzle, simultaneously with the deposition of the bead.

According to another feature, the plastic substance storage comprises a cartridge provided with a plunger, and the device including an actuator which is adapted to push the plunger in order to extrude the plastic substance through the extrusion nozzle.

The present disclosure also concerns a method for implementing a device of the previously described type, wherein it comprises at least a step of piloting the robotic arm in space according to a theoretical trajectory which is predetermined, and a step of correcting the theoretical trajectory according to the measurements collected by the force feedback sensor, so that the bearing force of the nozzle on the profile, measured by the force feedback sensor, tends towards a predefined value, so as to enable the nozzle to remain in contact on the profile.

According to another feature of the method, the speed of displacement of the robotic arm is servo-controlled according to the amount of plastic substance actually deposited.

According to another feature, the method includes a step of monitoring the plastic substance bead, which comprises processing the monitoring data and validating or invalidating the amount of the deposited bead.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective overall view which illustrates the device for depositing a bead of a plastic substance on a profile including a robotic arm, according to the teachings of the present disclosure;

FIG. 2 is a perspective detail view along line A-A of FIG. 1, which illustrates the plastic substance deposition effector and the associated actuator;

FIG. 3 is a perspective detail view which illustrates a plastic substance bead deposited on the profile by the device of FIG. 1;

FIG. 4 is a schematic side view which illustrates the 45-degree inclination of the ejection nozzle; and

FIG. 5 is a schematic front view which illustrates the 10-degree inclination of the ejection nozzle.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In the description and the claims, the terminology longitudinal, vertical and transverse will be used in a non-limiting manner with reference to the trihedron L, V, T indicated in the figures.

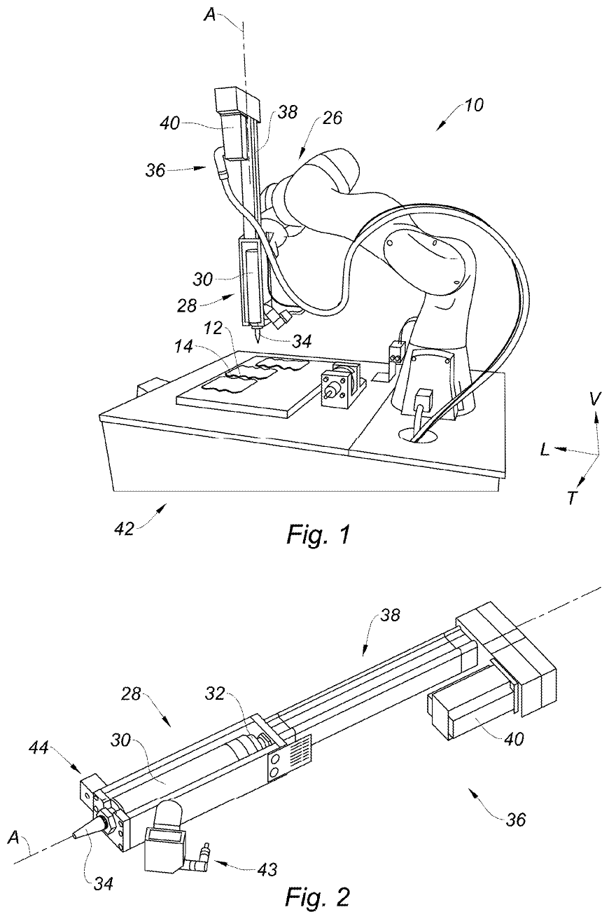

In FIG. 1, there is represented a device 10 for depositing a bead 12 of a plastic substance.

By “plastic substance,” it should be understood any material which, at some point of the preparation process thereof, can undergo a permanent deformation and take the shape that is desired to be imparted thereon. According to the variation described herein, the plastic substance is a mastic sealant which is adapted to make a sealing gasket.

The bead 12 is deposited on a profile 14 which is shaped as a scalloped border.

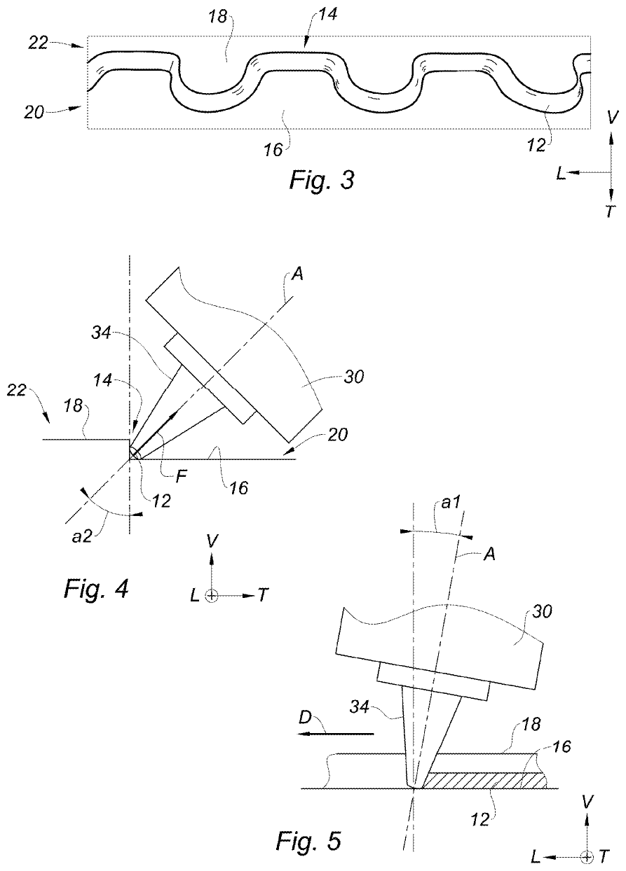

As shown in FIGS. 3 and 4, the profile 14 is delimited by a first deposit face 16 and a second deposit face 18 which are arranged at a right angle so as to form the profile 14.

The first deposit face 16 and the second deposit face 18 respectively belong to a first support part 20 and to a second overlap part 22.

The device 10 includes a robotic arm 26.

The robotic arm 26 carries an effector 28 for deposition which comprises a plastic substance cartridge 30, the plastic substance cartridge 30 being provided with a plunger 32 and an extrusion nozzle 34.

The plastic substance cartridge 30, the plunger 32 and the extrusion nozzle 34 extend axially along an extrusion axis A.

In addition, the device 10 includes an actuator 36 comprising an electric cylinder 38 which is associated to a motor 40.

The electric cylinder 38 includes a free end which is sliding axially along the extrusion axis A and which is fastened on the plunger 32 of the plastic substance cartridge 30 to push the plastic substance through the extrusion nozzle 34.

The motor 40 is a direct-current motor which is associated with a rotary encoder (not represented), to allow determining the rotational speed of the motor shaft and therefore the plastic substance flow rate through the extrusion nozzle 34.

Also, the device 10 according to the present disclosure includes a force feedback sensor (not shown) which is housed within the robotic arm, and which allows measuring the force F (illustrated in FIG. 4) applied by the extrusion nozzle 34 on the deposit faces 16, 18, according to the extrusion axis A.

The force feedback sensor may include several elements adapted to measure a force, such as for example stress gauges.

According to another aspect, the device 10 includes an electronic calculator 42 which implements a computer program.

The computer program is designed so as to pilot the robotic arm 26 in space according to a theoretical trajectory which is predetermined.

The theoretical trajectory is a three-dimensional digital representation of the geometry of the profile 14 on which the bead 12 should be deposited.

Nonetheless, the profile 14 may have a geometry which substantially differs from the theoretical trajectory, for example if the profile 14 has a manufacturing defect.

Thus, the computer program is designed so as to correct the theoretical trajectory according to the measurements collected by the force feedback sensor, so that the bearing force F of the extrusion nozzle 34 on the deposit faces 16, 18 measured by the force feedback sensor, tends towards a predefined value, so as to enable the extrusion nozzle 34 to remain in contact on the deposit faces 16, 18.

Typically, if the profile 14 includes a recess that is not referenced by the theoretical trajectory, the force feedback sensor will measure a decrease in the bearing force F of the extrusion nozzle 34 on the profile 14 when the extrusion nozzle 34 will reach the recess, this measured decrease immediately resulting in a correction which comprises displacing the extrusion nozzle 34 towards the profile 14 so that the bearing force F tends towards the predetermined value.

According to a variation of the present disclosure, the predefined value of the force F to be reached should not be too high in order to not mark the profile. According to another variation of the present disclosure, the predefined value of the force F is equal to about ten Newtons.

The computer program implemented by the electronic calculator 42 is designed so as to enable the extrusion nozzle 34 to divert the theoretical trajectory in a more pronounced way in a plane perpendicular to the progress direction of the extrusion nozzle 34, that is to say in a transverse vertical plane according to FIG. 4, so as to enhance the quality of the bead 12.

In other words, the displacement of the extrusion nozzle 34 is “flexible” in a plane perpendicular to the progress direction of the extrusion nozzle 34 and “rigid” in the plane of displacement of the extrusion nozzle 34.

In addition, the device 10 includes a deposition sensor 43 which is mounted on the frame of the effector 28, opposite the outlet mouthpiece of the extrusion nozzle 34.

The deposition sensor 43 is adapted to measure the amount of plastic substance deposited on the deposit face, the speed of displacement of the robotic arm 26 is servo-controlled according to the amount of plastic substance actually deposited, by the computer program.

According to one variation, the deposition sensor 43 comprises a laser sensor. The deposition sensor 43 allows measuring the geometry of the bead 12, and in particular the height of the bead 12.

Thus, if the height of the bead 12 measured by the deposition sensor 43 exceeds a predetermined value, the speed of displacement of the effector 28 is increased so that the amount of deposited plastic substance forming the bead 12 is reduced.

Without limitation, the deposition sensor 43 may also include a digital camera or any other type of sensor adapted to determine the geometry of the bead 12.

Complementarily, the speed of displacement of the effector 28 is also servo-controlled according to the extrusion flow rate of the plastic substance, which is determined by the rotary encoder associated to the motor 40.

As shown in FIG. 5, the extrusion nozzle 34 extends axially perpendicularly to its progress direction D, with an inclination by angle a1 of ten degrees, so as to smooth the bead 12 simultaneously with the deposition of the bead 12, in a longitudinal and vertical plane according to FIG. 5.

According to the example described in FIG. 5, the inclination of the extrusion nozzle 34 according to the angle a1 is directed rearwards. Nonetheless, the inclination of the extrusion nozzle 34 according to the angle a1 may be directed forwards.

Similarly, referring to FIG. 4, the extrusion nozzle 34 extends axially along the bisector of the angle delimited by the first deposit face 16 and the second deposit face 18, in a vertical and transverse plane according to FIG. 4.

In other words, the extrusion nozzle 34 is inclined by about 45 degrees with respect to the first deposit face 16 and to the second deposit face 18.

According to another aspect of the present disclosure, the device 10 includes a monitoring member 44 which is adapted to collect monitoring data relating to the physical aspect of the plastic substance of bead 12.

The monitoring data are collected by the monitoring member 44 during the deposition of the bead 12.

Nonetheless, without limitation, the monitoring data may be collected by the monitoring member 44 during a second movement of the robotic arm 26 which is performed after a first bead 12 deposit movement.

For example, the monitoring member 44 comprises a digital camera.

The computer program implemented by the electronic calculator 42 is designed so as to process the monitoring data output by the monitoring member 44, and to validate or invalidate the quality of the deposited plastic substance of bead 12, by comparison with a predetermined reference.

The present disclosure also concerns a method for the implementation of the previously described device 10.

The method comprises a step of piloting the robotic arm 26 in space according to the predetermined theoretical trajectory of the robotic arm 26.

Simultaneously with the piloting step, the method executes a step of correcting the theoretical trajectory according to the measurements collected by the force feedback sensor, so that the bearing force F of the extrusion nozzle 34 on the profile 14, measured by the force feedback sensor, tends towards a predefined value of about ten Newtons, so as to enable the extrusion nozzle 34 to remain in contact on the deposit faces 16, 18.

In addition, the method according to the present disclosure servo-controls the speed of displacement of the robotic arm 26 with the amount of plastic substance actually deposited which is measured by the deposition sensor 43, so as to obtain a bead 12 with a constant geometry.

The method also includes a step of monitoring the plastic substance of bead 12, which comprises processing the monitoring data provided by the monitoring member 44 and validating or invalidating the quality of the deposited bead 12.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A device for depositing a bead of a plastic substance on a profile delimited by at least one face for depositing the bead, the device comprising:
a robotic arm;
a deposition effector comprising an extrusion nozzle connected to a plastic substance storage and extending axially along an extrusion axis; and
a force feedback sensor allowing measuring a bearing force applied by the extrusion nozzle on the profile during a deposition of the bead;
wherein the device comprises an electronic calculator implementing a computer program which is configured to:
pilot the robotic arm in space according to a theoretical trajectory which is predetermined; and
correct the theoretical trajectory according to measurements collected by the force feedback sensor, so that the bearing force of the extrusion nozzle on the profile, measured by the force feedback sensor, tends towards a predefined value, so as to enable the extrusion nozzle to remain in contact with the profile.

2. The device according to claim 1, wherein the predefined value is equal to about ten Newtons.

3. The device according to claim 1, further comprising a deposition sensor adapted to measure an amount of plastic substance deposited on the profile, wherein the robotic arm has a speed of displacement that is servo-controlled according to the amount of plastic substance deposited on the profile.

4. The device according to claim 3, wherein the deposition sensor is a laser sensor directed towards the bead of plastic substance.

5. The device according to claim 1, wherein the robotic arm has a speed of displacement that is servo-controlled according to a speed of extrusion of the plastic substance.

6. The device according to claim 1, further comprising a monitoring member adapted to collect monitoring data relating to a physical aspect of the bead of plastic substance, and the computer program is configured to process the monitoring data and validate or invalidate quality of the deposited bead of plastic substance.

7. The device according to claim 6, wherein the monitoring data are collected by the monitoring member during the deposition of the bead.

8. The device according to claim 1, wherein a smoothing of the bead is carried out by the extrusion nozzle, simultaneously with the deposition of the bead.

9. The device according to claim 1, wherein the plastic substance storage is a cartridge provided with a plunger, and the device further comprises an actuator adapted to push the plunger to extrude the plastic substance through the extrusion nozzle.

10. A method for implementing a device for depositing a bead of a plastic substance according to claim 1, wherein the method comprises:
piloting the robotic arm in space according to a theoretical trajectory which is predetermined; and
correcting the theoretical trajectory according to measurements collected by the force feedback sensor, so that the bearing force of the extrusion nozzle on the profile, measured by the force feedback sensor, tends towards a predefined value, so as to enable the extrusion nozzle to remain in contact with the profile.

11. The method according to claim 10, wherein the robotic arm has a speed of displacement that is servo-controlled according to an amount of plastic substance deposited on the profile.

12. The method according to claim 10 further comprising monitoring the bead of plastic substance and processing monitoring data and validating or invalidating quality of the deposited bead.
